(19) United States
(12) Patent Application Publication
(10) Pub. No.: US 2009/0105013 A1
(43) Pub. Date: Apr. 23, 2009

(54) ULTRAVIOLET LIGHT RESISTANT POLYMER COMPOSITIONS AND METHODS OF MAKING AND USING

(76) Inventors: Edwin Charles Slagel, Avondale, AZ (US); Michael James Slagel, Peoria, AZ (US); Wallace Lee Hanson, JR., Duluth, GA (US); Shenshen Wu, Shrewsbury, MA (US); Ray Vernon Scott, JR., Blacksburg, VA (US); Kevin Ward Light, Acworth, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/239,776

(22) Filed: Sep. 27, 2008

Related U.S. Application Data
(60) Provisional application No. 60/976,138, filed on Sep. 28, 2007.

(51) Int. Cl. A63B 37/12; C08G 63/08; C08G 63/06; C08G 18/32; C08L 75/04

(52) U.S. Cl. 473/378; 525/415; 525/450; 525/453; 524/590

(57) ABSTRACT

Curable polyurethane/polyurea hybrid compositions that are particularly useful, when cured, as the outer layer and/or at least one inner layer of golf balls, are disclosed. Cured compositions are also disclosed. In addition, methods of increasing the ultraviolet light resistance of a golf ball layer using the curable polyurethane/polyurea hybrid compositions are disclosed. In addition, processes of making the polymer compositions are disclosed.

### CROSS-REFERENCE TO RELATED APPLICATIONS

This application claims the benefit of U.S. Application No. 60/976,138 filed Sep. 28, 2007, the disclosure of which is incorporated herein by reference.

### TECHNICAL FIELD

The invention relates generally to curable polymer compositions that are particularly useful, when cured, as the outer layer and/or at least one inner layer of golf balls, to the cured compositions, to golf balls comprising the cured composition, to methods of increasing the ultraviolet (UV) light resistance of a golf ball layer using the curable polymer compositions, and to the processes of making the curable polymer compositions.

### BACKGROUND

Polymeric compounds can often be susceptible to degradation from ultraviolet light. This can lead to changes in color, chalkiness on the surface, or cracking. The addition of carbon black or light stabilizers can prevent or minimize this from occurring. Coating the surface of the polymer with a layer that absorbs or blocks UV light is also an alternative.

Despite these efforts, there is still a need for golf balls with increased resistance to ultraviolet light without negatively impacting the other desirable properties of golf balls. The present invention is directed to these, as well as other, important needs.

### SUMMARY

The invention relates generally to curable polymer compositions that are particularly useful, when cured, as the outer layer and/or at least one inner layer of golf balls, to the cured compositions, to golf balls comprising the cured composition, and to methods of increasing UV light resistance of a golf ball layer using the curable polymer compositions. One of the features of this invention is that water is used to increase the urea linkage content in the backbone of the polymer composition.

In one embodiment, the present invention is directed to a composition, comprising:

a. a prepolymer comprising a reaction product of:
i. at least one aliphatic polyisocyanate comprising at least two isocyanates;
ii. at least one polyol selected from the group consisting of substituted hydrocarbon, substituted polyester, substituted polycaprolactone, substituted polyether, and substituted polycarbonate;
   wherein said polyol is substituted with at least two hydroxys;
   wherein said polyol has a weight-average molecular weight of about 500 daltons to about 4000 daltons; and
   wherein an equivalent ratio of said hydroxys of said polyol to said isocyanates of said polyisocyanate is about 0.3 to about 0.99;
iii. water;
   wherein an equivalent ratio of said water to said isocyanates of said polyisocyanate is about 0.01 to about 0.7; and
   wherein an equivalent ratio of said isocyanates of said polyisocyanate to a total of said water and said hydroxys in said polyol is greater than about 1; and
iv. an optional catalyst;

b. at least one amine curing agent;
wherein said amine curing agent is substituted with at least two aminos;
wherein said amine curing agent has a weight-average molecular weight of about 90 daltons to about 400 daltons;
wherein an equivalent ratio a total of said aminos of said amine curing agent to said isocyanates of said prepolymer is about 0.85 to about 1.4.

In another embodiment, the present invention is directed to a layer, comprising a cured composition described above.

In another embodiment, the invention is directed to a golf ball, comprising:

a. a core; and

b. at least one layer described above.

In another embodiment, the invention is directed to a method of improving ultraviolet light resistance of a layer, comprising a step of forming a cured layer from said composition described above.

In yet other embodiments, the present invention is directed to a process, comprising the steps of:

a. forming a prepolymer by reacting:
i. at least one aliphatic polyisocyanate comprising at least two isocyanates;
ii. at least one polyol selected from the group consisting of substituted hydrocarbon, substituted polyester, substituted polyether, and substituted polycarbonate;
   wherein said polyol is substituted with at least two hydroxys;
   wherein said polyol has a weight-average molecular weight of about 500 daltons to about 4000 daltons; and
   wherein an equivalent ratio of said hydroxys of said polyol to said isocyanates of said polyisocyanate is about 0.3 to about 0.99; and
iii. water;
   wherein an equivalent ratio of said water to said isocyanates of said polyisocyanate is about 0.01 to about 0.7; and
   wherein an equivalent ratio of said isocyanates of said polyisocyanate to a total of said water and said hydroxys in said polyol is greater than about 1; and
iv. an optional catalyst;

b. reacting said prepolymer with at least one amine curing agent;
wherein said amine curing agent is substituted with at least two aminos;
wherein said amine curing agent has a weight-average molecular weight of about 90 daltons to about 400 daltons;
wherein an equivalent ratio of a total of said aminos of said amine curing agent to said isocyanates of said prepolymer is about 0.85 to about 1.4.

### DETAILED DESCRIPTION OF ILLUSTRATIVE EMBODIMENTS

The present invention relates generally to curable polymer compositions that are particularly useful, when cured, as the outer layer and/or at least one inner layer of golf balls, to the cured composition, to golf balls comprising the cured composition, and to methods of increasing the ultraviolet light resistance of a golf ball layer using the curable polymer compositions. The novel polymers provide many beneficial properties, many of which overcome shortcomings of the prior art. One of the features of this invention is that water is used to increase the urea linkage content in the backbone of the polymer composition.

As used herein, the term “polyurea” refers to an oligomer or a polymer that is the result of a chemical reaction between an isocyanate and an amine. A polyurea is an oligomer or a polymer that has two or more urea linkages.

As used herein, the term “polyurethane” refers to an oligomer or a polymer that is the result of a chemical reaction between an isocyanate and a polyol. A polyurethane is an oligomer or a polymer that has two or more urethane linkages.

As used herein, the phrase “polyurea/polyurethane hybrid” refers to an oligomeric or a polymeric mixture that is the result of a chemical reaction between an isocyanate and a mixture of polyol and amine reactants. A polyurea/polyurethane hybrid is an oligomer or a polymer that has two or more urethane linkages and two or more urea linkages.

As used herein, the term “polymer” refers to, but is not limited to, oligomers, adducts, homopolymers, random copolymers, pseudo-copolymers, statistical copolymers, alternating copolymers, periodic copolymer, block copolymers, bipolymers, terpolymers, quaterpolymers, other forms of copolymers, substituted derivatives thereof, and mixtures thereof. These polymers can be linear, branched, block, graft, monodisperse, polydisperse, regular, irregular, tactic, isotactic, syndiotactic, stereoregular, atactic, stereoblock, single-strand, double-strand, star, comb, dendritic, and/or ionomeric.

As used herein, the term “prepolymer” refers to a polymer of relatively low molecular weight, usually intermediate between that of the monomer and the final polymer or resin, which may be mixed with compounding additives, and which is capable of being hardened by further polymerization or crosslinking during or after a forming process.

As used herein, the term “polyol” refers to any aliphatic or aromatic compound containing at least two free hydroxyl groups. Suitable polyols may have a backbone chain selected from the following classes: saturated or unsaturated, linear or branched or cyclic (including heterocyclic), aliphatic or aromatic (including mononuclear or polynuclear aromatics). Such polyols can include glycols.

As used herein, the term “polyamine” refers to any aliphatic or aromatic compound containing at least two amine groups. In practicing the processes disclosed herein, the selection of a suitable amine is simply a matter of choice. For example, suitable polyamines may have a backbone chain selected from the following classes: saturated or unsaturated, linear or branched or cyclic (including heterocyclic), aliphatic or aromatic (including mononuclear or polynuclear aromatics).

As used herein, the term “cure” as used in connection with a composition, e.g., “a cured composition,” shall mean changing the properties of any monomer, oligomer, or polymer components of the composition by treatment with a heat process, a radiation process, a reaction process with one or more chemical reactant combinations or a combination thereof. These chemical reactants are referred to herein as curing agents.

As used herein, the term “curable” as used in connection with a composition, e.g., “a curable material,” shall mean any monomer, oligomer, or polymer components of the composition whose properties are changed by treatment with a heat process, a radiation process, a reaction process with one or more chemical reactant combinations or a combination thereof.

As used herein, the term “cure rate” refers to the amount of time a particular mixture of prepolymer and curing processes take to react and form the final product. The rate of curing for a polymer mixture can be measured, for example, by a Vibrating Needle Curemeter (VNC) that is manufactured by Rapra Technology Limited. It is achieved by suspending a steel needle in the curing formulation. The needle is vibrated vertically by a small electrodynamic vibrator driven by a signal generator. Resistance to its movement is ultimately recorded as the voltage output.

As used herein, the term “pot life” refers to the length of time a polymer mixture retains a viscosity low enough for it to be suitable for processing.

As used herein, the term “percent NCO” or “% NCO” refers to the percent by weight of free, reactive, and unreacted isocyanate functional groups in an isocyanate-functional molecule or material. The total formula weight of all the NCO groups in the molecule or material, divided by its total molecular weight, and multiplied by 100, equals the percent NCO.

As used herein, the term “transparency” refers to the amount of light that is transmitted through a substance. Transparency can be determined by UV-VIS-NIR spectrophotometry.

As used herein, the term “ultraviolet (UV) light resistance” refers to the ability of a substance to absorb, transmit, reflect or refract ultraviolet light without becoming altered or egraded. This practice covers specific procedures and test conditions that are applicable for fluorescent UV exposure of plastics conducted in accordance with ASTM Practices G 151 and G 154. This practice also covers the preparation of test specimens, the test conditions best suited for plastics, and the evaluation of test results. Ultraviolet light resistance may be determined by ASTM D 4329-05, “Standard Practice for Fluorescent UV Exposure of Plastics,” ASTM International and is incorporated herein.

As used herein, the term “tensile strength” refers to the maximum amount of pulling stress that a material can be subjected to before failure or breakage. ASTM D-412-98a, “Standard Test Methods for Vulcanized Rubber and Thermoplastic Rubbers and Thermoplastic Elastomers-Tension,” describes the procedures used to evaluate the tensile (tension) properties of vulcanized rubbers and thermoplastic rubbers and thermoplastic elastomers. These protocols include Test Method A-Dumbbell and Straight Section Specimens; Test Method B-Cut Ring Specimens.

As used herein, the term “ultimate elongation” refers to the percentage increase in length that occurs before it breaks under tension. ASTM D-412-98a, “Standard Test Methods for Vulcanized Rubber and Thermoplastic Rubbers and Thermoplastic Elastomers-Tension,” describes the procedures used to evaluate the ultimate elongation properties of vulcanized rubbers and thermoplastic rubbers and thermoplastic elastomers. These protocols include Test MethodA-Dumbbell and Straight Section Specimens; Test Method B-Cut Ring Specimens.

As used herein, the term “tear strength” refers to the force required to tear a specified test specimen divided by the specimen thickness. ASTM D624-00 Type C, “Standard Test Method for Tear Strength of Conventional Vulcanized Rubber and Thermoplastic Elastomers” (Die C Tear Strength) and ASTM D-624-00 Type T, “Standard Test Method for Tear Strength of Conventional Vulcanized Rubber and Thermoplastic Elastomers” (Split Tear Strength) describe procedures used to evaluate the tear strength of vulcanized thermoset rubber and thermoplastic elastomers.

As used herein, the term “material hardness” refers to indentation hardness of non-metallic materials in the form of a flat slab or button as measured with a durometer. The durometer has a spring-loaded indentor that applies an indentation load to the slab, thus sensing its hardness. The material hardness can indirectly reflect upon other material properties, such as tensile modulus, resilience, plasticity, compression resistance, and elasticity. Standard tests for material hardness include ASTM D2240-02b. Unless otherwise specified, material hardness reported herein is in Shore D. Material hardness is distinct from the hardness of a golf ball portion as measured directly on the golf ball (or other spherical surfaces). The difference in value is primarily due to the construction, size, thickness, and material composition of the golf ball components (i.e., center, core, and/or layers) that underlie the portion of interest. One of ordinary skill in the art would understand that the material hardness and the hardness as measured on the ball are not correlated or convertible.

As used herein, the term “golf ball” includes but is not limited to the definitions and restrictions set by the U.S. Golf Association and The Royal and Ancient Golf Club of St. Andrews, which are incorporated herein by reference.

As used herein, the term “dispersant” refers to an additive that increases the stability of a suspension of powders or pigments in a liquid medium.

Any numeric references to amounts, unless otherwise specified, are “by weight.” As used herein, the term “equivalent weight” is the molecular weight of a compound divided by the number of reactive (functional) groups in that compound. This definition is that which is found in the Urethane and Polyurethane Industry Glossary. For example, the molecular weight of pure toluene diisocyanate (TDI) is 174, and it has two isocyanate functional groups. Therefore, the equivalent weight of TDI is 174/2 or 87. In a prepolymer formulation, the number of equivalents of TDI must be balanced against the number of equivalents of water and polyol in order to achieve stoichiometry.

As used herein, the term “equivalent” is defined as the number of moles of a functional group in a given quantity of material, and calculated from material weight divided by equivalent weight, as defined above.

As used herein, the term “equivalent ratio” is defined as the ratio between the number of equivalents of a given quantity of material to the number of equivalents of another given quantity of material.

As used herein, the term “saturated” or “substantially saturated” means that the compound or material of interest is fully saturated (i.e., contains no double bonds, triple bonds, or aromatic ring structures), or that the extent of unsaturation is negligible, e.g. as shown by a bromine number in accordance with ASTM E234-98 of less than about 10, preferably less than about 5.

As used herein, the term “compression,” also known as “ATTI compression” or “PGA compression,” refers to points derived from a Compression Tester (ATTI Engineering Company, Union City, N.J.), a scale well known in the art for determining relative compression of a spherical object. Compression is a property of a material as measured on a golf ball construction (i.e., on-ball property), not a property of the material per se.

As used herein, the term “light stabilizer,” refers to any compound that absorbs, alters or reflects any wavelength of the electromagnetic spectrum, especially in the visible and ultra-violet ranges, such that the properties of a polymer composition are improved, preserved or remain unaltered.

In one embodiment, the present invention is directed to a composition, comprising:

a. a prepolymer comprising a reaction product of:
i. at least one aliphatic polyisocyanate comprising at least two isocyanates;
ii. at least one polyol selected from the group consisting of substituted hydrocarbon, substituted polyester, substituted polycaprolactone, substituted polyether, and substituted polycarbonate;
   wherein said polyol is substituted with at least two hydroxys;
   wherein said polyol has a weight-average molecular weight of about 500 daltons to about 4000 daltons; and
   wherein an equivalent ratio of said hydroxys of said polyol to said isocyanates of said polyisocyanate is about 0.3 to about 0.99;
iii. water;
   wherein an equivalent ratio of said water to said isocyanates of said polyisocyanate is about 0.01 to about 0.7; and
   wherein an equivalent ratio of said isocyanates of said polyisocyanate to a total of said water and said hydroxys in said polyol is greater than about 1; and
iv. an optional catalyst;

b. at least one amine curing agent;
wherein said amine curing agent is substituted with at least two aminos;
wherein said amine curing agent has a weight-average molecular weight of about 90 daltons to about 400 daltons;
wherein an equivalent ratio a total of said aminos of said amine curing agent to said isocyanates of said prepolymer is about 0.85 to about 1.4.

In certain embodiments of the process, the prepolymer is a polyurethane/polyurea hybrid, polyurethane/polyurea ionomer, or a mixture thereof.

In certain preferred embodiments, the prepolymer is at least partially formed from a reaction between an aliphatic amine and said polyisocyanate, wherein said aliphatic amine is formed from the reaction of said water and said polyisocyanate.

In certain preferred embodiments, the weight-average molecular weight of said polyol is about 1500 daltons to about 3000 daltons.

Some of the isocyanates that can be used in the preparation of the compositions of this invention are diisocyanatodicyclohexylmethanes, diisocyantomethyl cyclohexanes and preferable mixtures thereof containing from about 10-100 percent of the trans-trans isomer of 4,4′-methylene bis(cyclohexyl isocyanate), also hereinafter referred to a “PICM”, 1,3-bis(isocyantomethyl)cyclohexane, 1,4-bis(isocyantomethyl)cyclohexane or mixtures thereof. Other compounds usually present in the mixtures of positional isomers and/or stereoisomers of the diisocyanate-dicyclohexylmethane used in this invention are the cis-trans and cis-cis isomers of PICM and stereoisomers of 2,4′-methylene bis(cyclohexyl isocyanate).

These, as well as, the trans-trans PICM isomer, are present in amounts which can be controlled by the procedures used to prepare the diisocyanate-dicyclohexylmethane. Preferred diisocyanates are isomeric PICM mixtures which are liquid at 25C or less. Such liquid PICM's contain less than about 20 percent trans-trans isomer and less than about 72 percent cis-cis isomer. An especially preferred mixture contains the trans-trans, cis-trans and cis-cis isomers of PICM in a weight ratio of about 20:65:15 and optionally small amounts up to about 5 percent by weight of 2,4′-methylene bis(cyclohexyl isocyanate). These preferred mixtures can be conveniently handled and give high-quality polyurethanes.

The PICM used in this invention is prepared by phosgenating the corresponding 4,4′-methylene bis(cyclohexyl amine) PACM by procedures well know in the art, of U.S. Pat. No. 2,644,007, U.S. Pat. No. 2,680,127 and U.S. Pat. No. 2,908,703. The PACM isomer mixtures, which upon phosgenation yield PICM that is a liquid at room temperature, are also well known in the art and can be obtained by hydrogenation of methylene dianiline under mild conditions and/or by fractional crystallization of PACM isomer mixtures in the presence of water and alcohols such as methanol and ethanol.

In certain preferred embodiments, the aliphatic diisocyanate is 1,3-bis(isocyantomethyl)cyclohexane; 1,4-bis(isocyantomethyl)cyclohexane; methylene bis(4-cyclohexyl isocyanate); 4,4′-methylene bis(cyclohexyl isocyanate); 2,4-methylene bis(cyclohexyl isocyanate); 1,6-hexamethylene-diisocyanate; dimer of 1,6-hexamethylene diisocyanate; symmetric and asymmetric trimer of 1,6-hexamethylene diisocyanate; 4,4′-dicyclohexylmethane diisocyanate; isophorone diisocyanate; or a mixture thereof.

In certain preferred embodiments, the aliphatic diisocyanate is methylene bis(4-cyclohexyl isocyanate). In certain other preferred embodiments, the aliphatic diisocyanate is 1,3-bis(isocyantomethyl)cyclohexane. In yet other preferred embodiments, the aliphatic diisocyanate is 1,4-bis(isocyantomethyl)cyclohexane.

Glycols which may be used to prepare the compositions of the invention include polyoxyalkylene ether glycols and polyester glycols. These glycols have number average molecular weights of about 700 to 1,000. Glycols having molecular weights of about 750 to 900 are especially effective in producing high quality polyurethanes.

Illustrative of suitable polyoxyalkylene ether glycols are poly-1,2-propylene ether glycol, poly-1,3-propylene ether glycol, and polytetramethylene ether glycol. Polyoxyalkylene ether glycols useful in this invention can be prepared by condensing epoxides or other cyclic ethers as is well known in the art.

Representative polyesters useful in this invention include polycaprolactones and polyesters based on esterification of dicarboxylic acids of four to ten carbon atoms, such as adipic, succinic and sebacic acids, and low molecular weight glycols of two to eight carbon atoms such as ethylene glycol, propylene glycol, diethylene glycol, 1,4-butanediol and 1,6-hexandiol. The polycaprolactones are prepared by condensing caprolactone in the presence of difunctional active hydrogen compounds such as water or the above enumerated low molecular weight glycols. Polyesters obtained by esterification of dicarboxylic acids and glycols can be derived by well-known esterification or transesterification procedures. The preferred materials for this invention are the polycaprolactones of the glycols of two to ten carbon atoms.

In certain preferred embodiment, the polyol is a 1,4-butanediol initiated polycaprolactone; 1,4-butanediol; 1,4-cyclohexyldimethylol; 1,5-pentanediol initiated polycaprolactone; 1,6-hexanediol initiated polycaprolactone; 1,6-hexanediol; 2,3-butanediol; 2,3-dimethyl-2,3-butanediol; 2-methyl-1,4-butanediol; 2-oxepanone, acrylic polyol; 3-methyl-1,4-butanediol; amine-terminated C₃₆ dimerate polyesters; amine-terminated polycaprolactone; C₃₆ dimerate polyester polyol; diethylene glycol initiated polycaprolactone; hydroxy terminated lactone ester with a molecular weight between approximately 1000 and 3000 daltons; hydroxy-terminated liquid isoprene rubber; hydroxy-terminated polyesters of dimerized fatty acids; hydroxy-terminated polyesters of dimethylol proprionic acid; hydroxy-terminated polyesters of isopthalic sulfonic acid; methylene bis(4-cyclohexyl isocyanate); neopentyl glycol initiated polycaprolactone; ortho-phthalate-1,6-hexanediol polyester polyol; poly(ethylene oxide capped oxypropylene) glycol; poly(hexamethylene adipate) glycol; poly(hexamethylene carbonate) glycol; poly(oxypropylene) glycol; poly(phthalate carbonate) glycol; polybutadiene glycol; polybutylene adipate glycol; polycaprolactone glycol, polycaprolactone polyol; polycaprolactone polyol; polycarbonate glycols containing bisphenol A; polyester glycolpolyester polyol; polyethylene adipate glycol; polyethylene propylene adipate glycol; polyethylene terephthalate polyester polyol; polyoxyalkylene ether glycol; polytetramethylene ether glycol initiated polycaprolactone; polytetramethylene ether glycol; propylene glycol initiated polycaprolactone; propylene glycol; trimethylol propane initiated polycaprolactone; trimethylol propane; or a mixture thereof.

In certain preferred embodiments, the polyol is a hydroxy terminated lactone ester with a molecular weight between approximately 1000 daltons and 3000 daltons, polycaprolactone glycol; polyoxyalkylene ether glycol; polyester glycol; or a mixture thereof.

In certain preferred embodiments, the polyol is a polycaprolactone polyol.

In certain preferred embodiments, the polyol is a hydroxy terminated lactone ester with a molecular weight between approximately 1000 daltons and 3000 daltons.

In certain preferred embodiments, the amine curing agent is 1,2-bis-(sec-butylamino)benzene; 1,4-bis-(sec-butylamino) benzene; 2,2′-diethyl-4,4′-diamino-dicyclohexyl methane; 2,2′-dimethyl-4,4′-diamino-dicyclohexyl methane; 2-propanol-1,1′-phenylaminobis; 3,3′ dimethylpolyaminocycloamine; 3,3′-diethyl-4,4′-diamino-dicyclohexyl methane; 3,3′-dimethyl-4,4′-bis(sec-butylamino)-dicyclohexylmethane; 3,3′-dimethyl-4,4′-diamino-dicyclohexyl methane; 3,5-diethyltoluene-2,4-diamine; 3,5-diethyltoluene-2,6-diamine; 3,5-dimethylthio-2,4-toluenediamine; 3,5-dimethylthio-2,6-toluenediamine; 4,4′-bis(sec-butylamino)-dicyclohexylmethane; 4,4′-bis-(sec-butylamino)-diphenylmethane; 4,4′-diamino-dicyclohexyl methane; 4,4′-dibutyl diamino diphenyl methane; 4,4′-methylene bis(2-chloroaniline); 4,4′-methylenebis (2-ethylaniline); amine-terminated polyesters of dimerized fatty acid; amine-terminated polyesters of dimethylol proprionic acid; amine-terminated polyesters of isophthalic sulfonic acid; diethyltoluene diamine; dimethylthio-2,4-toluenediamine; dimethylthio-2,6-toluenediamine; dimethylthiotoluene diamine; ethylene glycol; isophorone-acrylonitrile adduct; N,N′-dialkyldiamino diphenyl methane; N,N′-diisopropyl-isophorone diamine; polyoxypropylene diamine; polytetramethylene ether diamine; polytetramethyleneoxide-di-p-aminobenzoate; trimethyleneglycol-di-p-aminobenzoate; or a mixture thereof.

In certain preferred embodiments, the amine curing agent is diethyltoluene diamine. In certain other preferred embodiments, the amine curing agent is diethyltoluene diamine; 4,4′-methylene bis(2-ethylaniline); 4,4′-methylene bis(cyclohexyl amine) or a combination thereof.

In certain preferred embodiments, the equivalent ratio of said water to said isocyanates of said polyisocyanate is about 0.03 to about 0.65. In certain more preferred embodiments, the equivalent ratio of said water to said isocyanates of said polyisocyanate is about 0.05 to about 0.5. In certain even more preferred embodiments, the equivalent ratio of said water to said isocyanates of said polyisocyanate is about 0.07 to about 0.4.

In certain preferred embodiments, the equivalent ratio of said isocyanates of said polyisocyanate to total of said hydroxys in said polyol and said water is about 1.5 to about 2.5.

In certain embodiments of the process, a catalyst is added to the prepolymer composition. The catalyst serves to facilitate the polymerization process between reactants in the prepolymer composition.

In certain embodiments, the catalyst is an organo tin catalyst.

In certain preferred embodiments, the organo tin catalyst is dibutyltin carboxylate; dibutyltin dimaleate; dibutyltin laurate; dibutylin dilaurate; dimethyltin carboxylate; dimethyltin carboxylate; dimethyltin mercaptide; or a mixture thereof.

In certain preferred embodiments, the organo tin catalyst is dibutyltin carboxylate.

In certain preferred embodiments, the organo tin catalyst is dibutyltin mercaptide.

In certain preferred embodiments, the equivalent ratio of said aminos of said amine curing agent to said isocyanates of said prepolymer is about 0.9 to about 0.98.

In certain embodiments, the prepolymer may further comprise a catalyst neutralizer. The catalyst neutralizer is designed to slow, inhibit or quench the reactivity of the catalyst.

In certain preferred embodiments, the catalyst neutralizer is a copolymer of organic phosphate esters and modified fatty acids.

In certain preferred embodiments, the organo tin catalyst may be neutralized by the addition of organic phosphate esters.

In certain preferred embodiments, the organo tin catalyst may be neutralized by the addition of zeolites.

In certain embodiments, the composition may further comprise at least one ultraviolet light stabilizer. An ultraviolet light stabilizer can be an anionic, cationic, nonionic, zwitterionic, neutrally charged or amphoteric composition that is capable of absorbing ultraviolet radiation. In certain preferred embodiments, the ultraviolet light stabilizer is a cyanoacrylate, a cinnamate, an aminobenzoate, a triazine, a hydroxyflavone, a salicylate, benzotriazole, a benzophenone, or a mixture thereof.

In certain embodiments, the composition may further comprise at least one hindered amine light stabilizer. Hindered amine light stabilizers are compounds that contain a functionality that can prevent the degradation or discoloration of the cured composition when exposed to ultraviolet light. These hindered amine light stabilizers can be an anionic, cationic, nonionic, zwitterionic, neutrally charged or amphoteric composition. These hindered amine light stabilizers are not limited to sebacates and malonates. In certain preferred embodiments the hindered amine light stabilizer is bis(1,2,2,6,6-pentamethyl-4-piperidyl) sebacate, methyl 1,2,2,6,6-pentamethyl-4-piperidyl sebacate, bis(1-octyloxy-2,2,6-tetramethyl-4-piperidyl) sebacate, bis(1,2,2,6,6-pentamethyl-4-piperidinyl)-[[3,5-bis(1,1-dimethylethyl)-4-hydroxyphenyl]methyl]butylmalonate or a mixture thereof.

In certain embodiments, the composition may further comprise at least one surfactant. Surfactants are added to prevent disruptions in the prepolymer composition from any gases that may be created during the polymerization process. The surfactants can be anionic, cationic, nonionic, zwitterionic, neutrally charged or amphoteric and mixtures thereof. The surfactants can be silicone based or non-silicone based. Such surfactants include but are not limited to alkyl sulfates, sodium lauryl sulfate, sodium sulfonate of kraft lignin, a long chain fatty acid ester containing multiple ether linkage, a long chain fatty acid ester having alkyl amino linkages, polyvinyl pyrrolidone, a long chain fatty acid ester, a long chain fatty acid ester having multiple complex amino, a sodium salt of polymerized carboxylic acid, tetrapotassium salt of ethylene diamine tetraacetic acid, alkaline salts, magnesium salts, ammonium salts, amine salts, amino alcohol salts of alkyl sulphates, alkyl ether sulphates, alkylamido ether sulphates, alkylaryl polyether sulphates, monoglyceride sulphates, alkyl sulphonates, alkylamide sulphonates, alkylaryl sulphonates, olefin sulphonates, paraffin sulphonates, alkyl sulphosuccinates, alkyl ether sulphosuccinates, alkylamide sulphosuccinates, alkyl sulphosuccinamates, alkyl sulphoacetates, alkyl phosphates, alkyl ether phosphates, acyl sarcosinates, acyl isethionates, N-acyl taurates, polyethoxylated fatty acids, polyoxypropylenated fatty acids, polyglycerolated fatty acids, copolymers of ethylene oxide and propylene oxide, condensates of ethylene oxide and of propylene oxide with fatty alcohols, polyethoxylated fatty amides, polyglycerolated fatty amides, polyethoxylated fatty amines, oxyethylenated fatty acid esters of sorbitan, fatty acid esters of sucrose, fatty acid esters of polyethylene glycol, alkylpolyglycosides, amide derivatives of N-alkylglucamines, carbamate derivatives of N-alkylglucamines, aldobionamides, amine oxides, secondary aliphatic amines, tertiary aliphatic amines salts of fatty amines, tertiary fatty amines quaternary ammonium salts, imidazoline derivatives, cationic amine oxides, and mixtures thereof.

In certain embodiments, the composition may further comprise at least one coloring agent. Coloring compositions may be organic and inorganic and are added to color the composition. In certain preferred embodiments, the coloring composition is a dye, a pigment, or a colorant.

In certain embodiments, the cured composition is cured with curing agents.

In one embodiment, the cured composition forms a layer. Layers can be formed from molding, extrusion, deposition or a combination thereof.

In certain preferred embodiments, the cured composition is transparent.

In one embodiment, the present invention is directed to a golf ball, comprising:

a. a core; and

b. at least one layer described above.

In certain preferred embodiments, the layer forms an outer cover of said golf ball.

In certain preferred embodiments, the outer cover of said golf ball is transparent.

In certain preferred embodiments, the outer cover of said golf ball is translucent.

In other preferred embodiments, the outer cover of said golf ball is opaque.

In one embodiment, the present invention is directed to a method of improving ultraviolet light resistance of a layer, comprising a step of:

forming a cured layer from said composition described above.

In one embodiment, the present invention is directed to a process, comprising the steps of:

a. forming a prepolymer by reacting:
i. at least one aliphatic polyisocyanate comprising at least two isocyanates;
ii. at least one polyol selected from the group consisting of substituted hydrocarbon, substituted polyester, substituted polyether, and substituted polycarbonate;
   wherein said polyol is substituted with at least two hydroxys;
   wherein said polyol has a weight-average molecular weight of about 500 daltons to about 4000 daltons; and
   wherein an equivalent ratio of said hydroxys of said polyol to said isocyanates of said polyisocyanate is about 0.3 to about 0.99; and
iii. water;
   wherein an equivalent ratio of said water to said isocyanates of said polyisocyanate is about 0.01 to about 0.7; and
   wherein an equivalent ratio of said isocyanates of said polyisocyanate to a total of said water and said hydroxys in said polyol is greater than about 1; and
iv. an optional catalyst;

b. reacting said prepolymer with at least one amine curing agent;
wherein said amine curing agent is substituted with at least two aminos;
wherein said amine curing agent has a weight-average molecular weight of about 90 daltons to about 400 daltons;
wherein an equivalent ratio of a total of said aminos of said amine curing agent to said isocyanates of said prepolymer is about 0.85 to about 1.4.

In certain embodiments of the process, the prepolymer is at least partially formed from a reaction between an aliphatic amine and said polyisocyanate, wherein said aliphatic amine is formed from the reaction of said water and said polyisocyanate.

In certain embodiments of the process, at least a portion of said aliphatic polyisocyanate is reacted with said at least a portion of said polyol prior to the reaction with said water.

In certain embodiments of the process, at least a portion of said aliphatic polyisocyanate is reacted with said water prior to the reaction with said at least one polyol.

In certain embodiments of the process, the water is added in liquid phase.

In certain other embodiments of the process, the water is added in gas phase.

In certain embodiments of the process, a catalyst neutralizer is added to the prepolymer composition after the prepolymer is formed.

In certain embodiments, the process of forming the prepolymer may further comprise the addition of a catalyst neutralizer wherein said catalyst neutralizer is added to the prepolymer composition before the addition of the curing agent.

In certain embodiments, the process of forming the prepolymer may further comprise the addition of a catalyst neutralizer wherein said catalyst neutralizer is added to the prepolymer composition after the addition of the curing agent.

Polymers of the present invention are a product of a reaction between at least one polyurethane/polyurea hybrid prepolymer with at least one polyamine curing agent. In a preferred embodiment of the prepolymer synthesis step of this invention is the reaction product of a glycol with an aliphatic polyisocyanate. A preferred embodiment of the prepolymer synthesis step of this invention is the reaction product of polycaprolactone glycol with 4,4′-methylene bis(cyclohexyl isocyanate). The preferred embodiment of the prepolymer synthesis step of this invention is the reaction product of polycaprolactone glycol with 1,3-bis(isocyantomethyl)cyclohexane, 1,4-bis(isocyantomethyl)cyclohexane or a combination thereof. The number of urea linkages in the prepolymer composition is increased by the addition of water. A preferred embodiment of this invention is to use one or more isomers of diethyltoluene diamine as the curing agents. However, it can be contemplated that the polyurethane/polyurea polymer synthesis step of this invention could employ a wide range of polyols, polyamines, and polyisocyanates.

The urea content of the prepolymer of the invention is increased by the addition of water to the isocyanate reaction chamber. The reaction between the polyisocyanate and the water causes at least some of the polyisocyanate to convert to an amine and become another potential reactant with the remaining polyisocyanate. This causes the prepolymer to have a higher number of urea linkages than it would in the absence of water. This process creates both urea and urethane linkages in the prepolymer. Addition of the amine curing agent further increases the urea content of the polymer backbone.

Preferably, the cover composition and/or the intermediate layer composition comprise from about 1% to about 100% of the polymers of the present invention. In other preferred embodiments, the cover composition and/or the intermediate layer composition comprise from about 10% to about 95% of the polymers of the present invention. In other preferred embodiments, the cover composition and/or the intermediate layer composition comprise from about 25% to about 90% of the polymers of the present invention. In certain preferred embodiments, the intermediate layer composition comprises one or more other polymers and/or other materials as described below. Such other polymers include, but are not limited to polyurethane/polyurea ionomers, polyurethane/polyurea hybrids, polyurethanes, polyureas, epoxy resins, and mixtures thereof. Unless otherwise stated herein, all percentages are given in percent by weight of the total composition of the golf ball layer in question.

Other conventional ingredients, e.g., density-controlling fillers, ceramics and glass spheres are well known to the person of ordinary skill in the art and may be included in the cover and intermediate layer compositions of the present invention in amounts effective to achieve their known purpose.

Water can be added in either liquid or gas phase. Water can also be reacted first, followed by the polyol addition.

The present invention can be used in forming golf balls of any desired size. The USGA dictates that the size of a competition golf ball must be larger than 1.680 inches in diameter. Golf balls of any size can be used for leisure golf play. The preferred diameter of the golf balls is from about 1.680 inches to about 1.800 inches. The more preferred diameter is from about 1.680 inches to about 1.760 inches. A diameter of from about 1.680 inches to about 1.740 inches is most preferred, however diameters anywhere in the range of from 1.70 to about 1.95 inches can be used. Oversize golf balls with diameters above about 1.760 inches to as big as 2.75 inches are also within the scope of the present invention.

### EXAMPLES

The present invention is further defined in the following Examples, in which all parts and percentages are by weight and degrees are Fahrenheit, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

Example 1: A diisocyanate was added to the reaction vessel and an agitator was turned on, and glycol components which were heated to 110° F. to 160° F. were then added to the diisocyanate. When mixed, 2 to 40 ppm of an organo tin catalyst was added to the reactants. After addition of the catalyst, an exothermic reaction occurred and raised the reaction temperature to 230° F. to 275° F. When the reaction was complete and the reactants were cooled to 210° F. to 240° F., water was added. Prior to the water addition, 1 to 20 ppm of a surfactant was added to deplete bubble formulation during the water diisocyanate reaction that released carbon dioxide.

The performance data for Example 1 is shown in Table 1.

TABLE 1

| Properties | |
|---|---|
| Tensile Strength | 7800 psi |
| Elongation | 420% |
| Tensile stress | |
| 100% | 1615 psi |
| 200% | 2370 psi |
| 300% | 3900 psi |
| Tear, trouser split | 420 pli |
| Shore D Hardness | 48 |
| Color | very low color |

Example 2: To the reaction vessel that was equipped with an agitator, heating, and dry nitrogen inlet, 2 equivalents of Desmodur W® methylene bis(4-cyclohexyl isocyanate) were added. The agitator was started, the vessel was purged with dry nitrogen, and the heat controls were set to 130° F. to 160° F. CAPA 2107A polycaprolactone glycol (a hydroxyl terminated lactone ester with a molecular weight of 1000)/0.2 equivalents and CAPA 2203A polycaprolactone glycol (a 1,4-butanediol initiated lactone ester with a molecular weight of 2000)/0.6 equivalents were added. When the reactants were mixed, the organo tin catalyst, Fomrez UL-2 dibutyltin carboxylate was added. When the temperature reached 250° F., the heat source was removed. When the reactants cooled to 230° F., the surfactant was added and the agitator speed was increased to form a vortex and 0.2 equivalents of water were added. The foaming action was controlled by the speed of agitation. When the reaction had gone to completion with the reactants at 230° F., the following compounds were added: 1% Tinuvin® 328 2-(2H-benzotriazol-2-yl)-4,6-ditertpentylphenol, 0.5% Lowilite® 92 which is a mixture of bis(1,2,2,6,6-pentamethyl-4-piperidinyl) sebacate and methyl(1,2,2,6,6-pentamethyl-4-piperidinyl) sebacate, and 0.3% Irganox® 1010 tetrakis[methylene 3,5-di-(tert-butyl-4-hydroxyhydro-cinnamate)]-methane. If required, pigment or dyes can be added at this time. When the temperature reached 160° F., contents were dumped, evacuated, and purged with dry nitrogen and seal. The equivalent weight of the prepolymer was determined and test sheets 0.070 inches were cast using Ethacure®100 LC diethyltoluene diamine as the curative at 0.95 NH₂/1.0 NCO. The test sheets were cured 3 hours at 185° F. followed by 14 days room temperature aging prior to testing. After casting, high strength was reached in 24 hours with full cure in 30 days at 77° F. Resistance to UV degradation was evaluated on a weathering rack facing south at an angle of 45 degrees in Phoenix, Ariz. After 90 days, no change in color or appearance was noted.

Example 3: To the reaction vessel that was equipped with an agitator, heating, and dry nitrogen inlet, 203.7 (2.1 equivalents) of 1,3-bis(isocyantomethyl)cyclohexane, or 1,4-bis(isocyantomethyl)cyclohexane or a mixture thereof were added. The agitator was started, the vessel was purged with dry nitrogen, and the heat controls were set to 130° F. to 160° F. CAPA 2107A polycaprolactone glycol (a hydroxyl terminated lactone ester with a molecular weight of 1000)/101.7 g (0.2 equivalents) and CAPA 2203A polycaprolactone glycol (a 1,4-butanediol initiated lactone ester with a molecular weight of 2000)/593.5 g (0.6 equivalents) which had been preheated to 120° F. to 160° F. were added. The agitator and heat were turned on. When the reaction temperature reached 120° F. to 140° F., 10 ppm Fomrez UL-2 (dibutyltin carboxylate) was added to the reactants. When an exothermic reaction started, the temperature was allowed to reach 250° F. to 275° F. and the heat source was removed. When the reaction had gone to completion and the temperature had cooled to 230° F. to 235° F., a surfactant was added in the amount of 2 ppm. When the reaction had gone to completion and the temperature had cooled to 230° F. to 235° F., a surfactant was added in the amount of 2 ppm. The agitator speed was increased to form a vortex and 1.8 g (0.2 equivalents) of water were added. The foaming action was controlled by the speed of agitation. When the reaction had gone to completion with the reactants at 230° F., the following compounds were added: 1.2% Tinuvin® 328 2-(2H-benzotriazol-2-yl)-4,6-ditertpentylphenol, 0.9% Lowilite® 92 which is a mixture of bis(1,2,2,6,6-pentamethyl-4-piperidinyl) sebacate and methyl(1,2,2,6,6-pentamethyl-4-piperidinyl) sebacate, and 0.4% Irganox® 1010 tetrakis[methylene 3,5-di-(tert-butyl-4-hydroxyhydro-cinnamate)]-methane. When the temperature reached 160° F. to 170° F. the reactants were evacuated, purged with dry nitrogen, and sealed. If required, pigment or dyes were added at this time. To eliminate any yellow color, a trace amount of a blue dye can be added to the reactants. The equivalent weight of the prepolymer was determined and test sheets 0.070 inches thick were cast using a curing agent mixture of 78.3 g (0.88 equivalents) Ethacure 100LC and 14.2 g (0.12 equivalents) Dimethyl PACM. Curing agent mixture can range from 0.85 NH₂/1.0 NCO to 1.0 NH₂/1.0 NCO. A range of 0.95 NH₂/1.0 NCO is preferred. The test sheets were cured 3 hours at 185° F. followed by 14 days room temperature aging prior to testing. After casting, high strength was reached in 24 hours with full cure in 30 days at 77° F. Resistance to UV degradation was evaluated on a weathering rack facing south at an angle of 45 degrees in Phoenix, Ariz. After 90 days, no change in color or appearance was noted.

For the purpose of further clarifying the equivalent ratio, please see the Table 2 below.

TABLE 2

| | | No. of | | | |
|---|---|---|---|---|---|
| | | Functional | | | |
| | Molecular | Groups per | Equivalent | Equivalent | Amount |
| Molecule Name | Weight | Equivalent | weight | used | used |
| (as used herein) | (g/mol) | (mol/equiv) | (g/equiv) | (equiv) | (g) |
| CAPA 2107A | 1017 | 2 hydroxys | 508.5 | 0.2 | 101.7 |
| CAPA 2203A | 1978.2 | 2 hydroxys | 989.1 | 0.6 | 593.5 |
| H₂O | 18 | 2 hydroxys | 9 | 0.2 | 1.8 |
| Ethacure 100LC | 178 | 2 aminos | 89 | 0.88 | 78.3 |
| Dimethyl PACM | 236 | 2 aminos | 118 | 0.12 | 14.2 |
| 1,3- | 194 | 2 isocyanates | 97 | 2.1 | 203.7 |
| bis(isocyantomethyl)cyclohexane | | | | | |

The equivalent ratio of the OH of the polyol to the NCO of the polyisocyanate is about 0.3 to about 0.95. In the above example, there are about 0.8 equivalents of OH of the polyol in the reaction that come from the 0.2 equivalents from CAPA 2107A and 0.6 equivalents from CAPA 2203A. There are 0.8 equivalents of OH of the polyol to the 2.1 equivalents of NCO of the polyisocyanate, which gives an equivalent ratio of about 0.38.

0.8 equiv/2.1 equiv=0.38

The equivalent ratio of the OH of water to the NCO of the polyisocyanate is about 0.05 to about 0.7. In the above example, there are about 0.2 equivalents of OH of the water to the 2.1 equivalents of NCO of the polyisocyanate, which gives an equivalent ratio of about 0.095.

0.2 equiv/2.1 equiv=0.095

The equivalent ratio of the NCO of the polyisocyanate to a total of the OH of the water and the OH of the polyol is greater than about 1. In the above example, there are about 2.1 equivalents of NCO of the polyisocyanate to 1.0 equivalents of OH of the water and polyols, which gives an equivalent ratio of 2.1. The 1.0 equivalents of OH come from the 0.2 equivalents from CAPA 2107A, the 0.6 equivalents from CAPA 2203A and the 0.2 equivalents of water.

2.1 equiv/1.0 equiv=2.1

The equivalent ratio of the total of the NH₂ of the amine curing agent to the NCO of the prepolymer is about 0.85 to about 1.4. In the above example, there are about 0.9 equivalents of NCO of the polyisocyanate remaining after the reaction with the water, the polyols, and the polyamine that resulted from the reaction of the water. The exemplary reaction above began with 2.1 equivalents of polyisocyanate. This 2.1 equivalents was reduced after reaction with 0.2 equivalents of CAPA 2107A, 0.6 equivalents of CAPA 2203A, 0.2 equivalents of water and the 0.2 equivalents of polyamine that was produced by the reaction of the water with the polyisocyanate. There are only 0.9 equivalents of polyisocyanate remaining. This gives an equivalent ratio of 1.0 equivalents of polyamine curing agent to 0.9 equivalents of polyisocyanate, which is about 1.1.

1.0 equiv/0.9 equiv=1.1

Example 4: To the reaction vessel that was equipped with an agitator, heating, and dry nitrogen inlet, 2.4 equivalents of 1,3-bis(isocyantomethyl)cyclohexane, or 1,4-bis(isocyantomethyl)cyclohexane or a mixture thereof were added. The agitator was started, the vessel was purged with dry nitrogen, and the heat controls were set to 130° F. to 160° F. CAPA 2107A polycaprolactone glycol (a hydroxyl terminated lactone ester with a molecular weight of 1000)/0.15 equivalents and CAPA 2203A polycaprolactone glycol (a 1,4-butanediol initiated lactone ester with a molecular weight of 2000)/0.65 equivalents which had been preheated to 120° F. to 160° F. were added. The agitator and heat were turned on. When the reaction temperature reached 120° F. to 140° F., 10 ppm Fomrez UL-2 (dibutyltin carboxylate) was added to the reactants. When an exothermic reaction started, the temperature was allowed to reach 250° F. to 275° F. and the heat source was removed. When the reaction had gone to completion and the temperature had cooled to 230° F. to 235° F., a surfactant was added in the amount of 2 ppm. At the same time the water addition was started. When the reactants cooled to 230° F., the surfactant was added and the agitator speed was increased to form a vortex and 0.2 equivalents of water were added. The foaming action was controlled by the speed of agitation. When the reaction had gone to completion with the reactants at 230° F., the following compounds were added: 1.2% Tinuvin® 328 2-(2H-benzotriazol-2-yl)-4,6-ditertpentylphenol, 0.9% Lowilite® 92 which is a mixture of bis(1,2,2,6,6-pentamethyl-4-piperidinyl) sebacate and methyl(1,2,2,6,6-pentamethyl-4-piperidinyl) sebacate, and 0.4% Irganox® 1010 tetrakis[methylene 3,5-di-(tert-butyl-4-hydroxyhydro-cinnamate)]-methane. When the temperature reached 160° F. to 170° F. the reactants were evacuated, purged with dry nitrogen, and sealed. If required, pigment or dyes were added at this time. To eliminate any yellow color, a trace amount of a blue dye can be added to the reactants. A white pigment from Rebus can be added at 0.6% to 2.0% depending on degree of white necessary. The equivalent weight of the prepolymer was determined and test sheets 0.070 inches thick were cast using a curing agent mixture of 0.88 equivalents Ethacure 100LC and 0.12 equivalents dimethyl PACM. Curing agent mixture can range from 0.85 NH₂/1.0 NCO to 1.0 NH₂/1.0 NCO. A range of 0.95 NH₂/1.0 NCO is preferred. The test sheets were cured 3 hours at 185° F. followed by 14 days room temperature aging prior to testing. After casting, high strength was reached in 24 hours with full cure in 30 days at 77° F. Resistance to UV degradation was evaluated on a weathering rack facing south at an angle of 45 degrees in Phoenix, Ariz. After 90 days, no change in color or appearance was noted.

It is important to note that the above reaction can be carried out with water additions of up to 0.5 equivalents or higher with surprising results when using aliphatic polyisocyanates, especially 1,3-bis(isocyantomethyl)cyclohexane, 1,4-bis(isocyantomethyl)cyclohexane or a mixture thereof. The expectation with some polyisocyanates would be that the prepolymer reaction mixture would precipitate ureas with the addition of that number of equivalents of water. This does not occur when using 1,3-bis(isocyantomethyl)cyclohexane, 1,4-bis(isocyantomethyl)cyclohexane or a mixture thereof. The prepolymer composition yields a clear composition with superior qualities upon undergoing the curing process.

When ranges are used herein for physical properties, such as molecular weight, or chemical properties, such as chemical formulae, all combinations, and subcombinations of ranges specific embodiments therein are intended to be included.

The disclosures of each patent, patent application and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A composition, comprising:
a. a prepolymer comprising a reaction product of:
i. at least one aliphatic polyisocyanate comprising at least two isocyanates;
ii. at least one polyol selected from the group consisting of substituted hydrocarbon, substituted polyester, substituted polycaprolactone, substituted polyether, and substituted polycarbonate;
wherein said polyol is substituted with at least two hydroxys;
wherein said polyol has a weight-average molecular weight of about 500 daltons to about 4000 daltons; and
wherein an equivalent ratio of said hydroxys of said polyol to said isocyanates of said polyisocyanate is about 0.3 to about 0.99;
iii. water;
wherein an equivalent ratio of said water to said isocyanates of said polyisocyanate is about 0.01 to about 0.7; and
wherein an equivalent ratio of said isocyanates of said polyisocyanate to a total of said water and said hydroxys in said polyol is greater than about 1; and
iv. an optional catalyst;
b. at least one amine curing agent;
wherein said amine curing agent is substituted with at least two aminos;
wherein said amine curing agent has a weight-average molecular weight of about 90 daltons to about 400 daltons;
wherein an equivalent ratio a total of said aminos of said amine curing agent to said isocyanates of said prepolymer is about 0.85 to about 1.4.

2. The composition of claim 1,
wherein said prepolymer is a polyurethane/polyurea hybrid, polyurethane/polyurea ionomer, or a mixture thereof.

3. The composition of claim 1,
wherein said prepolymer is at least partially formed from a reaction between an aliphatic amine and said polyisocyanate;
wherein said aliphatic amine is formed from the reaction of said water and said polyisocyanate.

4. The composition of claim 1,
wherein the weight-average molecular weight of said polyol is about 1500 daltons to about 3000 daltons.

5. The composition of claim 1,
wherein said aliphatic polyisocyanate is 1,3-bis(isocyantomethyl)cyclohexane; 1,4-bis(isocyantomethyl)cyclohexane; methylene bis(4-cyclohexyl isocyanate); 4,4′-methylene bis(cyclohexyl isocyanate); 2,4-methylene bis(cyclohexyl isocyanate); 1,6-hexamethylene-diisocyanate; dimer of 1,6-hexamethylene diisocyanate; symmetric and asymmetric trimer of 1,6-hexamethylene diisocyanate; 4,4′-dicyclohexylmethane diisocyanate; isophorone diisocyanate; or a mixture thereof.

6. The composition of claim 1,
wherein said aliphatic polyisocyanate is methylene bis(4-cyclohexyl isocyanate).

7. The composition of claim 1,
wherein said aliphatic polyisocyanate is 1,3-bis(isocyantomethyl)cyclohexane.

8. The composition of claim 1,
wherein said aliphatic polyisocyanate is 1,4-bis(isocyantomethyl)cyclohexane.

9. The composition of claim 1,
wherein said polyol is a 1,4-butanediol initiated polycaprolactone; 1,4-butanediol; 1,4-cyclohexyldimethylol; 1,5-pentanediol initiated polycaprolactone; 1,6-hexanediol initiated polycaprolactone; 1,6-hexanediol, 2,3-butanediol; 2,3-dimethyl-2,3-butanediol; 2-methyl-1,4-butanediol; 2-oxepanone, acrylic polyol; 3-methyl-1,4-butanediol; amine-terminated C₃₆ dimerate polyesters; amine-terminated polycaprolactone; C₃₆ dimerate polyester polyol; diethylene glycol initiated polycaprolactone; hydroxy terminated lactone ester with a molecular weight between approximately 1000 and 3000 daltons; hydroxy-terminated liquid isoprene rubber; hydroxy-terminated polyesters of dimerized fatty acids; hydroxy-terminated polyesters of dimethylol proprionic acid; hydroxy-terminated polyesters of isophthalic sulfonic acid; methylene bis(4-cyclohexyl isocyanate); neopentyl glycol initiated polycaprolactone; ortho-phthalate-1,6-hexanediol polyester polyol; poly(ethylene oxide capped oxypropylene) glycol; poly(hexamethylene adipate) glycol; poly(hexamethylene carbonate) glycol; poly(oxypropylene) glycol; poly(phthalate carbonate) glycol; polybutadiene glycol; polybutylene adipate glycol; polycaprolactone glycol, polycaprolactone polyol; polycaprolactone polyol; polycarbonate glycols containing bisphenol A; polyester glycolpolyester polyol; polyethylene adipate glycol; polyethylene propylene adipate glycol; polyethylene terephthalate polyester polyol; polyoxyalkylene ether glycol; polytetramethylene ether glycol initiated polycaprolactone; polytetramethylene ether glycol; propylene glycol initiated polycaprolactone; propylene glycol; trimethylol propane initiated polycaprolactone; trimethylol propane; or a mixture thereof.

10. The composition of claim 1,
wherein said polyol is a hydroxy terminated lactone ester with a molecular weight between approximately 1000 and 3000 daltons, polycaprolactone glycol, polyoxyalkylene ether glycol, hydrocarbon polyol, polycarbonate polyol, polyester glycol, or a mixture thereof.

11. The composition of claim 1,
wherein said polyol is polycaprolactone polyol.

12. The composition of claim 1,
wherein said polyol is a hydroxy terminated lactone ester with a molecular weight between approximately 1000 and 3000 daltons.

13. The composition of claim 1,
wherein said amine curing agent is 1,2-bis-(sec-butylamino)benzene; 1,4-bis-(sec-butylamino) benzene; 2,2′-diethyl-4,4′-diamino-dicyclohexyl methane; 2,2′-dimethyl-4,4′-diamino-dicyclohexyl methane; 2-propanol-1,1′-phenylaminobis; 3,3′ dimethylpolyaminocycloamine; 3,3′-diethyl-4,4′-diamino-dicyclohexyl methane; 3,3′-dimethyl-4,4′-bis(sec-butylamino)-dicyclohexylmethane; 3,3′-dimethyl-4,4′-diamino-dicyclohexyl methane; 3,5-diethyltoluene-2,4-diamine; 3,5-diethyltoluene-2,6-diamine; 3,5-dimethylthio-2,4-toluenediamine; 3,5-dimethylthio-2,6-toluenediamine; 4,4′-bis(sec-butylamino)-dicyclohexylmethane; 4,4′-bis-(sec-butylamino)-diphenylmethane; 4,4′-diamino-dicyclohexyl methane; 4,4′-dibutyl diamine diphenyl methane; 4,4′-methylene bis(2-chloroaniline); 4,4′-methylenebis (2-ethylaniline); amine-terminated polyesters of dimerized fatty acid; amine-terminated polyesters of dimethylol proprionic acid; amine-terminated polyesters of isophthalic sulfonic acid; diethyltoluene diamine; dimethylthio-2,4-toluenediamine; dimethylthio-2,6-toluenediamine; dimethylthiotoluene diamine; ethylene glycol; isophorone-acrylonitrile adduct; N,N′-dialkyldiamino diphenyl methane; N,N′-diisopropyl-isophorone diamine; polyoxypropylene diamine; polytetramethylene ether diamine; polytetramethyleneoxide-di-p-aminobenzoate; trimethyleneglycol-di-p-aminobenzoate; or a mixture thereof.

14. The composition of claim 1,
wherein said amine curing agent is diethyltoluene diamine.

15. The composition of claim 1,
wherein said catalyst is an organo tin catalyst.

16. The composition of claim 1,
wherein said organo tin catalyst is dibutyltin carboxylate; dibutyltin dimaleate; dibutyltin laurate; dibutylin dilaurate; dimethyltin carboxylate; dimethyltin carboxylate; dimethyltin mercaptide; or a mixture thereof.

17. The composition of claim 1
wherein said organo tin catalyst is dibutyltin carboxylate.

18. The composition of claim 1
wherein said organo tin catalyst is dibutyltin mercaptide.

19. The composition of claim 1,
wherein the equivalent ratio of said water to said isocyanates of said polyisocyanate is about 0.03 to about 0.65.

20. The composition of claim 1,
wherein the equivalent ratio of said water to said isocyanates of said polyisocyanate is about 0.05 to about 0.5.

21. The composition of claim 1,
wherein the equivalent ratio of said water to said isocyanates of said polyisocyanate is about 0.07 to about 0.4.

22. The composition of claim 1,
wherein the equivalent ratio of said isocyanates of said polyisocyanate to a total of said hydroxys in said polyol and said water is about 1.5 to about 2.5.

23. The composition of claim 1,
wherein the equivalent ratio of said aminos of said amine curing agent to said isocyanates of said prepolymer is about 0.9 to about 0.98.

24. The composition of claim 1, further comprising a catalyst neutralizer.

25. The composition of claim 24,
wherein said catalyst neutralizer is a copolymer of organic phosphate esters and modified fatty acids.

26. The composition of claim 1, further comprising at least one ultraviolet light stabilizer.

27. The composition of claim 1, further comprising at least one hindered amine light stabilizer.

28. The composition of claim 1, further comprising at least one surfactant.

29. The composition of claim 1, further comprising at least one coloring agent.

30. The composition of claim 29,
wherein said coloring agent is selected from the group consisting of a dye, a pigment, and a colorant.

31. A layer, comprising a cured composition of claim 1.

32. The layer of claim 31, wherein said cured composition is transparent.

33. A golf ball, comprising:
a. a core; and
b. at least one layer of claim 31.

34. The golf ball of claim 33,
wherein said layer forms an outer cover of said golf ball.

35. The golf ball of claim 33,
wherein said outer cover of said golf ball is transparent.

36. The golf ball of claim 33,
wherein said outer cover of said golf ball is translucent.

37. The golf ball of claim 33,
wherein said outer cover of said golf ball is opaque.

38. A method of improving ultraviolet light resistance of a layer, comprising a step of:
forming a cured layer from said composition of claim 1.

39. A process, comprising the steps of:
a. forming a prepolymer by reacting:
i. at least one aliphatic polyisocyanate comprising at least two isocyanates;
ii. at least one polyol selected from the group consisting of substituted hydrocarbon, substituted polyester, substituted polyether, and substituted polycarbonate;
wherein said polyol is substituted with at least two hydroxys;
wherein said polyol has a weight-average molecular weight of about 500 daltons to about 4000 daltons; and
wherein an equivalent ratio of said hydroxys of said polyol to said isocyanates of said polyisocyanate is about 0.3 to about 0.99; and
v. water;
wherein an equivalent ratio of said water to said isocyanates of said polyisocyanate is about 0.01 to about 0.7; and
wherein an equivalent ratio of said isocyanates of said polyisocyanate to a total of said water and said hydroxys in said polyol is greater than about 1; and
vi. an optional catalyst;
b. reacting said prepolymer with at least one amine curing agent;
wherein said amine curing agent is substituted with at least two aminos;
wherein said amine curing agent has a weight-average molecular weight of about 90 daltons to about 400 daltons;
wherein an equivalent ratio of a total of said aminos of said amine curing agent to said isocyanates of said prepolymer is about 0.85 to about 1.4.

40. The process of claim 39,
wherein said prepolymer is at least partially formed from a reaction between an aliphatic amine and said polyisocyanate; and
wherein said aliphatic amine is formed from the reaction of said water and said polyisocyanate.

41. The process of claim 39,
wherein said at least a portion of said aliphatic polyisocyanate is reacted with said at least a portion of said polyol prior to the reaction with said water.

42. The process of claim 39,
wherein said at least a portion of said aliphatic polyisocyanate is reacted with said water prior to the reaction with said at least one polyol.

43. The process of claim 39,
wherein said water is added in liquid phase.

44. The process of claim 39,
wherein said water is added in gas phase.

45. The process of claim 39, further comprising the step of adding a catalyst neutralizer.

46. The process of claim 45,
wherein said catalyst neutralizer is added before the addition of the curing agent.

47. The process of claim 45, further comprising a catalyst neutralizer
wherein said catalyst neutralizer is added after the addition of the curing agent.
